(19) United States
(12) Patent Application Publication
(10) Pub. No.: US 2026/0097965 A1
(43) Pub. Date: Apr. 9, 2026

(54) CATALYTIC GRAPHITIZATION OF FUEL-GRADE PETROLEUM COKE

(71) Applicant: The Texas A&M University System, College Station, TX (US)

(72) Inventors: Ramu Banavath, College Station, TX (US); Micah J. Green, College Station, TX (US)

(73) Assignee: The Texas A&M University System, College Station, TX (US)

(21) Appl. No.: 19/352,279

(22) Filed: Oct. 7, 2025

Related U.S. Application Data
(60) Provisional application No. 63/704,517, filed on Oct. 7, 2024.

(51) Int. Cl. C01B 32/205; B01J 23/745; B01J 23/94; B01J 38/68; C10B 57/00; H01M 4/587; H01M 10/0525

(52) U.S. Cl. CPC C01B 32/205; B01J 23/745; B01J 23/94; B01J 38/68; C10B 57/005; H01M 4/587; H01M 10/0525; C01P 2002/82; C01P 2006/40

(57) ABSTRACT

The claimed invention is directed to a catalytic graphitization process to convert fuel-grade petroleum coke into battery-grade graphite using a recyclable catalyst derived from iron, nickel or cobalt.

### CROSS-REFERENCE(S) TO RELATED APPLICATIONS

This application claims priority to U.S. Provisional Application No. 63/704,517 filed Oct. 7, 2024, which is fully incorporated by reference herein.

### TECHNICAL FIELD

The present disclosure relates generally to treatment of petroleum coke and more particularly, but not by way of limitation, to catalytic graphitization of fuel-grade petroleum coke.

### BACKGROUND

This section provides background information to facilitate a better understanding of the various aspects of the disclosure. It should be understood that the statements in this section of this document are to be read in this light, and not as admissions of prior art.

The petrochemical industry faces numerous challenges regarding the sustainable use of its product streams, particularly in the case of petroleum coke (PC or “pet coke”). Currently, pet coke serves as a fuel for heating industries and as an anode in steel production, both contributing to greenhouse gas emissions and posing sustainability concerns. Therefore, converting fuel-grade pet coke into highly conductive and crystalline carbon materials could significantly enhance value generation. These materials find applications in energy storage and printed electronics, thereby promoting sustainable end uses for pet coke.

PC is a by-product derived from the thermal cracking of heavy crude oil residues, primarily in a refinery Coker unit. Refining one ton of crude oil typically yields around 31 kilograms of PC. PC is widely employed in modern metallurgical industries and is valued for its low cost (˜$200 per ton) and substantial annual production of over 28 million tons. PC is classified into various grades, such as needle coke (NC) (low sulfur) and fuel-grade coke (high sulfur), based on impurity levels and quality. The use of a PC is determined by its sulfur content, a harmful impurity that significantly affects the performance of batteries. High-quality coke, such as needle coke (with sulfur content<0.8 wt. %), is used as prebaked electrodes in the steel and aluminum industries for smelting. NC also serves as a primary raw material for producing synthetic graphite, which is typically used as a negative electrode in lithium-ion batteries. Low-quality fuel-grade cokes, such as sponge coke and shot coke (with sulfur content>3 wt. %), are primarily burned as fuel in cement industries and power plants.

The growing utilization of pet coke, especially fuel-grade pet coke, poses environmental risks because its combustion emits greenhouse gases that significantly contribute to global warming. Additionally, sulfur dioxide (SO₂) is also emitted, leading to acid rain that harms both animals and plants. Given these challenges, the petrochemical industry must manage petroleum coke sustainably to align with the United Nations Sustainable Development Goals (SDGs) of the 2030 Agenda, which aim to improve global development and quality of life. Companies aim to focus on producing materials and products that are functional, economical, and safe, in alignment with the seventeen SDGs of the 2030 Agenda.

The growing demand for energy storage systems has spurred interest in the production of synthetic graphite from PC. Various carbon-rich feedstocks, including needle coke (low-sulfur PC), coal, and biomass-derived carbon, are currently employed for this purpose. Among them, needle coke or low-sulfur PC is especially valued for its high carbon content, low cost, and intrinsically favorable structural characteristics. Although effective, the conventional graphitization method, commonly known as the Acheson process, is highly complex and energy-intensive. This method requires extremely high temperatures (>3000° C.) and an extended processing time of over seven days. In this process, extremely high temperatures (>3000° C.) are used for graphitization, consuming approximately 7.7*103 kWh per ton of product. The graphitization of high-sulfur PC or fuel-grade PC using the conventional Acheson process consists of several stages, including desulfurization, removal of non-carbon impurities, and graphitization. The high-sulfur PC will be roasted at 1500° C. for several hours to remove sulfur, followed by graphitization at temperatures exceeding 3000° C., which further increases energy consumption and releases high levels of greenhouse gases compared to the low-sulfur PC process. The removal of impurities is a critical prerequisite for effective graphitization of high-sulfur coke, which typically occurs at ultra-high temperatures around 2900° C. To address these issues, a sustainable low-temperature catalytic graphitization process for fuel-grade PC is desirable.

Catalytic graphitization has emerged as an effective strategy to lower the high temperatures typically required for converting amorphous or hard carbon into graphitic structures. Transition metal catalysts such as Ni, Co, and Fe reduce the activation energy for graphitization, enabling the transformation to occur at temperatures below 1000° C. Reported mechanisms include the dissolution-precipitation of carbon through metal particles and the formation/decomposition of metal carbides. For example, graphitic carbon has been synthesized from lignin via Joule heating (>2200° C.) without catalysts, and porous graphite with high crystallinity has been obtained at 800° C. using molten CaCl₂) or potassium ferrate as mediators. Despite the efficiency of these methods, challenges remain in catalyst recovery and in managing residual inorganic anions (e.g., Cl⁻, SO₄²⁻, NO₃⁻), which hinder electrochemical performance, scalability, and environmental compatibility.

Therefore, there is a need in the industry for a graphitization process that converts fuel-grade pet coke into battery-grade graphite but does not suffer from some of the drawbacks that exist in the current (prior art) processes.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 is a schematic illustration of a catalytic graphitization process of fuel-grade pet coke;

FIGS. 2A-2E illustrate the optimization of pet coke graphitization with varying different parameters, (2A) effect of catalyst content, (2B) effect of pet coke particle size, (2C) effect of Fe particle size, (2D) effect of pellet size, and (2E) effect of catalyst type;

FIGS. 3A-3E illustrate (3A) CV of LIB half-cell with PC derived graphite, (3B) comparison of CV of PC derived graphite-based LIB with natural graphite and artificial graphite, (3C) GCD of LIB with PC derived graphite, (3D) performance comparison of LIB prepared with PC derived graphite with natural graphite and artificial graphite, and (3E) cycling stability of LIBs made with PC derived graphite at a rate of 0.5C; and

FIG. 4 illustrates a 2D band of Raman spectra of pet coke at different temperatures.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described. Reference will now be made to more specific embodiments of the present disclosure and data that provides support for such embodiments. However, it should be noted that the disclosure below is for illustrative purposes only and is not intended to limit the scope of the claimed subject matter in any way.

Graphite shows great promise as an electrode material in energy storage industries and as a precursor for carbon nanomaterials such as graphene. Currently, high-grade needle coke is used to produce synthetic graphites, while low-grade fuel coke is used for fuel. However, transforming fuel-grade pet-coke into highly crystalline graphite is difficult because of its predominantly amorphous nature. To address this, a low-temperature graphitization method was developed specifically for converting fuel-grade pet-coke into highly crystalline graphite. Utilizing iron (Fe) as a catalyst, the activation energy required to transform the amorphous carbon in fuel-grade pet-coke into well-ordered graphite was successfully lowered. This method achieves highly crystalline graphite at an annealing temperature of a maximum of 1600° C., significantly lower than the high temperatures (>3000° C.) typically used in conventional graphitization processes. So, this invention allows for the efficient transformation of low-grade fuel coke into graphite in a solvent-free process.

Embodiments of the claimed invention are directed to a catalytic graphitization process to convert fuel-grade pet coke into battery-grade graphite. In certain embodiments, iron (Fe) powder is used as a catalyst to facilitate the graphitization of fuel-grade PC. The Fe catalyst reduces the activation energy of PC, enabling its transformation into highly crystalline graphite at relatively low temperatures (<1600° C.) within a few hours. The catalyst is recovered and reused as Fe₂O₃ for further graphitization, enhancing the sustainability of the process. The resulting fuel-grade-derived graphite was tested as a negative electrode for Li-ion batteries and compared with natural graphite (NG) and commercial battery-grade synthetic graphite. The performance of pet coke-derived graphite was comparable to NG and commercial synthetic graphite, demonstrating the potential of the catalytic graphitization process.

An embodiment of the claimed invention is directed to a catalytic graphitization strategy to upcycle fuel-grade petroleum coke into battery-grade graphite using iron as a reusable catalyst. The process achieves high graphitization at a temperature at or under 1600° C. within 24 hours, greatly reducing the energy and time requirements compared to conventional methods. Structural characterization confirms the formation of highly crystalline graphite, while electrochemical evaluation showed performance comparable to commercial anodes. The approach demonstrated robustness across catalyst loadings, coke particle size, pellet (batch) sizes, and with alternative catalysts such as Ni and Co, highlighting its industrial adaptability. Catalyst recovery in the form of Fe₂O₃ further improves resource efficiency and process sustainability. By converting a carbon-intensive byproduct of oil refining into a high-value material for energy storage, the claimed invention offers a practical route to lower emissions, enhances circularity, and supports the growing demand for sustainable graphite in lithium-ion batteries.

The methods discussed herein not only converts fuel-grade pet-coke into highly crystalline graphite, but also improves its conductivity. The methods convert fuel-grade pet-coke into highly crystalline graphite at comparatively low temperature with the help of a catalyst. These methods resolves the challenge of transforming fuel-grade pet-coke into valuable graphite efficiently and cost-effectively, thereby promoting the sustainable utilization of petrochemical industry byproducts. Furthermore, the methods successfully reduce contaminants, such as sulfur, nickel, and vanadium, present in pet-coke to a significant extent. Converting low-value fuel-grade pet-coke into valuable conductive and crystalline graphite offers substantial potential for efficient utilization, particularly in energy storage solutions. This process effectively uses industrial waste and prevents the release of greenhouse gases. This process can transform petrochemical industry waste, such as pet-coke, into highly valuable products like highly crystalline and conductive graphite. The resulting graphite is in high demand as an electrode material, especially in the energy storage device industry.

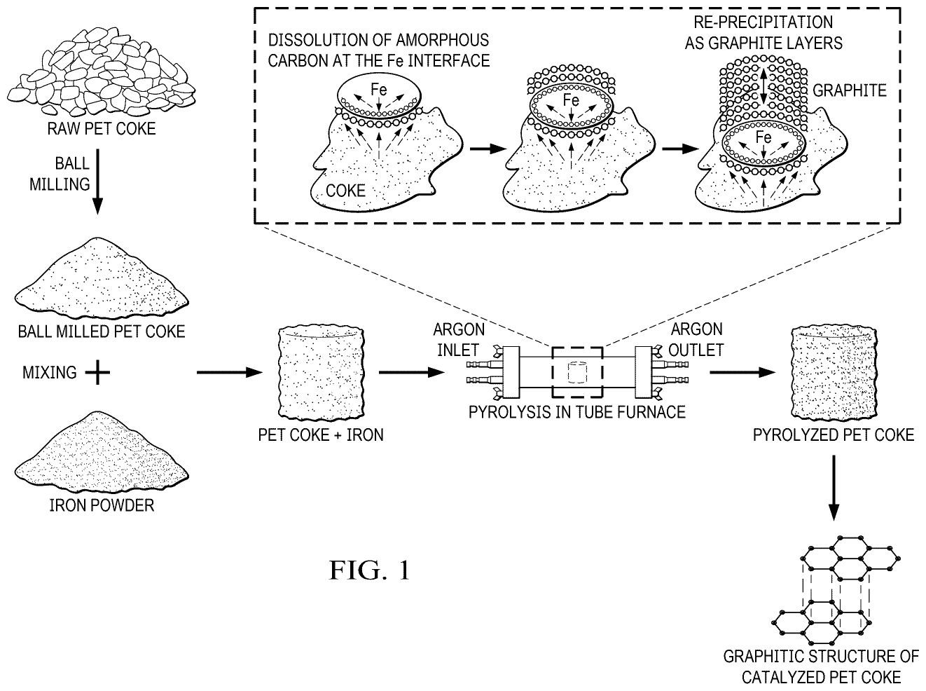

FIG. 1 illustrates a catalytic graphitization process according to aspects of the disclosure. Catalytic graphitization uses transition metals like nickel, cobalt, and iron to lower the activation energy needed to convert amorphous carbon into a high-crystalline structure. Using a catalyst facilitates graphite formation by encouraging the dissolution and precipitation of amorphous carbons, resulting in efficient graphitization at a relatively low temperature.

According to the experimental procedure, washed and ball-milled fuel-grade PC was combined with an iron (Fe) catalyst (PC:Fe=1:1) and shaped into pellets for pyrolysis. These pellets were then pyrolyzed in an argon atmosphere to induce graphitization. As shown in the inset of FIG. 1, the Fe catalyst lowers the activation energy, enabling the transformation of amorphous carbon in the fuel-grade PC into highly crystalline graphite at significantly lower temperatures than the conventional graphitization process (>3000° C.). In this method, Fe aids in the dissolution of amorphous carbon at reduced temperatures, which subsequently reprecipitates as graphitic layers during pyrolysis, converting the amorphous fuel-grade PC into highly crystalline graphite.

The pyrolysis of PC—Fe pellets was performed at various temperatures to find the effect of temperature for the catalytic graphitization of fuel-grade PC. Examples of temperatures used in the pyrolysis were 1300, 1400, 1500, and 1600° C. Each PC pellet was pyrolyzed for 24 hours. After pyrolysis, the PC powders were washed with 2M HCl to remove the Fe catalyst. The washed PC powders were then analyzed to gain insights into the graphitization process. SEM imaging was employed to observe the morphology of the raw fuel-grade PC and the catalytically graphitized PC at various temperatures. Initially, the irregularly shaped fuel-grade PC particles began forming layered structures after pyrolysis at 1300° C. As the temperature increased, these layered structures became more distinct, and by 1500° C., the particles had developed into uniform graphitic layers. After pyrolysis at 1600° C., the PC particles transformed into bulk-layered graphite.

To gain further insights into the graphitization of PC, XRD analysis was performed on both raw and catalyzed PC. As the temperature is increased, the crystallinity of PC increases. Additionally, the graphitization percentage increases with the pyrolysis temperature, reaching 97.7% after pyrolysis at 1600° C.

Fuel-grade PC is known to contain a high sulfur content. Compared to raw PC, the sulfur content of graphitized PC continuously decreased from 3.6% and was undetectable after treatment at 1500° C. Furthermore, the conductivity of PC increases with rising temperatures, directly correlating with the graphitization process of PC.

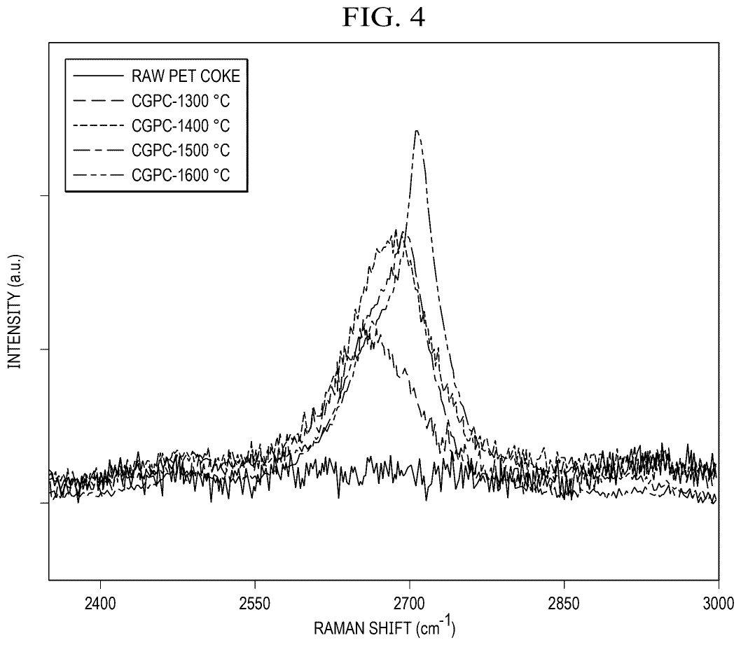

Raman spectroscopy was conducted on raw PC and pyrolyzed PC to better understand the quality and structural changes in synthesized graphite after pyrolysis. Raman spectroscopy reveals the emergence of a 2D band, indicating the transformation of amorphous carbon into long-range ordered graphitic sp² carbon. The narrowing of the G band and the decrease in the ID/IG ratio with increasing temperature further confirm enhanced graphitization and reduced defect density in the pyrolyzed PC. The G and 2D band shifts, approaching the typical peak positions of natural graphite, highlight the characteristic turbostratic 2D band of natural graphite around 2675 cm⁻¹. (FIG. 4) These results confirm that catalytic graphitization of fuel-grade PC at 1600° C. leads to its complete transformation into highly crystalline graphite, exhibiting features of natural graphite. Therefore, the characteristics observed in catalytically pyrolyzed PC at various temperatures verify the successful conversion of fuel-grade PC into highly crystalline graphite at 1600° C.

The effect of pyrolysis time on the graphitization of fuel-grade PC was examined at 1600° C. to identify the optimal duration for effective graphitization. PC—Fe pellets were subjected to pyrolysis for 3, 6, 12, and 24 hours at this temperature. The irregular PC particles progressively transformed into uniform layered graphite particles with increasing pyrolysis time, with no significant differences observed after 12 hours of treatment. The graphitization percentage rose with longer pyrolysis durations, peaking at 24 hours. A similar trend was observed for sulfur content, which decreased over time, and the conductivity, which increased with prolonged pyrolysis. Raman analysis showed consistent results, where the broadness of the G band and the ID/IG ratio decreased with increasing pyrolysis time, saturating after 12 hours. The G and 2D bands shifted rightward with longer pyrolysis durations, further confirming the transformation of PC into highly crystalline graphite. Based on these findings, 24 hours of pyrolysis results in the effective graphitization of fuel-grade PC.

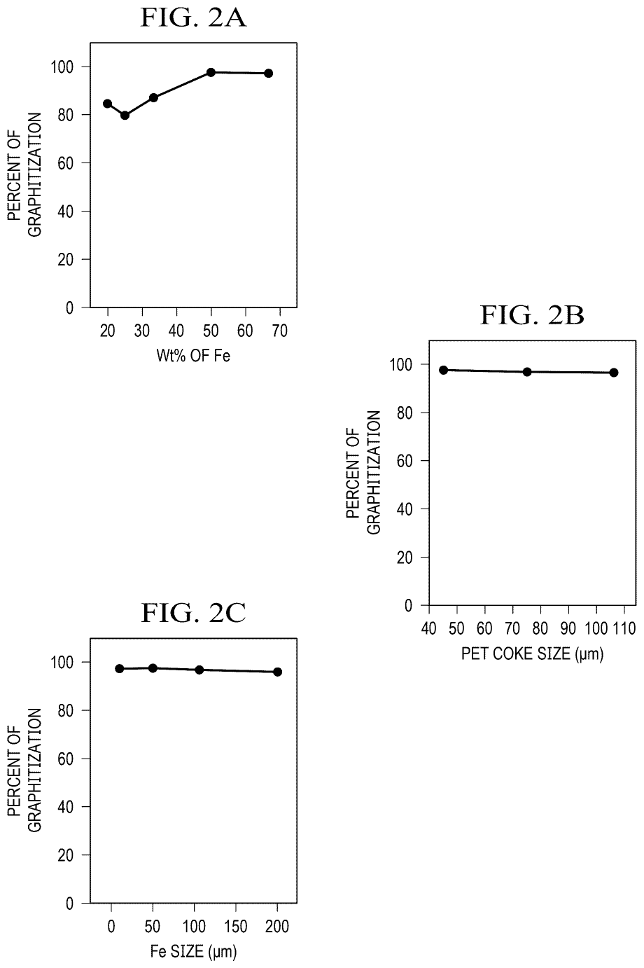

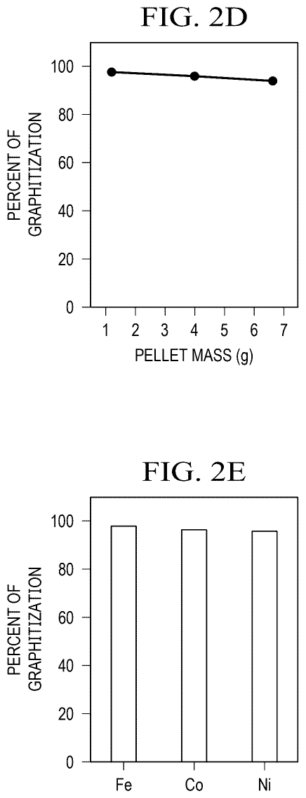

Various parameters including catalyst content (Fe), PC and Fe particle sizes, PC—Fe pellet size, and the type of catalyst (Fe, Ni, Co), were examined to understand their influence on the graphitization of fuel-grade PC. The pyrolysis temperature was maintained at 1600° C., and the duration was kept constant at 24 hours for all experiments. The XRD results for the effect of catalyst content on graphitization are shown in FIG. 2A. The degree of graphitization increased steadily from 20 to 50 wt % Fe and plateaued after 50 wt %, indicating that 50 wt % Fe is necessary and sufficient for high graphitization of fuel-grade PC. Therefore, 50 wt % of the catalyst was used in subsequent experiments.

The effect of PC particle size (45, 75, and 110 μm) was studied by maintaining the same Fe particle size (10 μm) for all experiments. The graphitization degree calculated from XRD plots slightly decreased as the PC particle size increased (FIG. 2B). Similarly, the effect of Fe particle size (10, 50, 100, and 200 μm) on graphitization was examined while keeping the PC particle size constant. A similar trend was observed, with a minimal decrease in graphitization degree from 97.28% to 95.83% for Fe particle sizes of 10 μm and 200 μm, respectively (FIG. 2C). These findings suggest that the particle sizes of both PC and Fe do not significantly affect the graphitization of PC. This makes the catalytic graphitization process more flexible for different grades of PC of different particle sizes.

The size of the PC—Fe pellet plays a crucial role in the scalability of the catalytic graphitization process. To evaluate this, PC—Fe pellets of varying weights (1.2, 4.5, and 7 grams) were prepared and done the pyrolysis under the same conditions. The XRD and graphitization degree plots for the effect of pellet size are shown in FIG. 2D. As illustrated, the graphitization degree remained high, decreasing slightly from 97.71% to 94.1% as the pellet weight increased from 1.2 to 7 grams. The morphology of PC particles from pellets of different weights revealed bulk-layered graphite particles for all samples, indicating that increasing pellet size did not alter the morphology of the PC-derived graphite. This suggests that larger pellet weights do not significantly affect the graphitization of PC-derived graphite. Moreover, similar graphitization levels can be achieved for larger pellet sizes by extending the pyrolysis time. EDS analysis of PC from pellets of various sizes post-washing showed that minute amounts of sulfur and iron remained in the larger pellet samples. These residual impurities could be further reduced by increasing the number of washing cycles. Consequently, these results suggest that the catalytic graphitization process can be easily scaled up while maintaining high-quality graphite production.

To ensure the process is scalable and adaptable to regions with varying resource availability, alternative catalysts such as Ni and Co were tested in addition to Fe. The XRD patterns and graphitization degree plots for these alternative catalysts are shown in FIG. 2E. The results indicate no significant difference in the degree of graphitization of PC-derived graphite when using Co or Ni as compared to Fe. This confirms that alternative catalysts can effectively be used to graphitize fuel-grade PC, making the process more adaptable and feasible across different regions.

To make the catalytic graphitization process more economically viable and sustainable, it is essential to recover and reuse the catalysts and facilitate the easy disposal of solvents. In certain embodiments, an iron hydroxide (Fe(OH)₂) precipitation method using NaOH is employed. The Fe(OH)₂ is subsequently converted into iron oxide (Fe₂O₃) and reused as a catalyst for the graphitization of PC. In this procedure, NaOH solution is gradually added to the Fe-dissolved HCl solution to raise the pH and convert Fe ions into Fe(OH)₂. When the solution's pH reaches 5, the Fe ions are completely transformed into Fe(OH)₂. The Fe(OH)₂ precipitate is then washed and annealed at 250° C. for 12 hours to convert it into iron oxide. The annealed Fe₂O₃ is then mixed with PC and reused as a catalyst for the graphitization of PC. As the pH of the HCl solution approaches neutrality, the washed solution can be discarded, making this process more environmentally friendly.

Fuel-grade PC-derived graphite powder can be used to fabricate lithium-ion battery (LIB) anodes. PC-derived graphite electrochemical performance was compared with that of both natural and synthetic commercial battery-grade graphite samples. Based on the process optimization of the catalytic graphitization process the best degree of graphitization is achieved with a 1:1 ratio PC:Fe which is treated at 1600° C. for 24 hours.

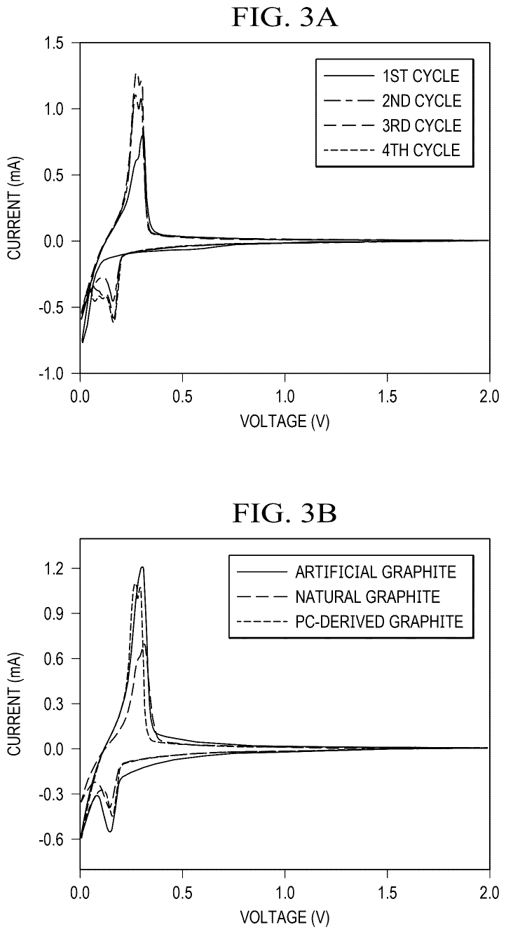

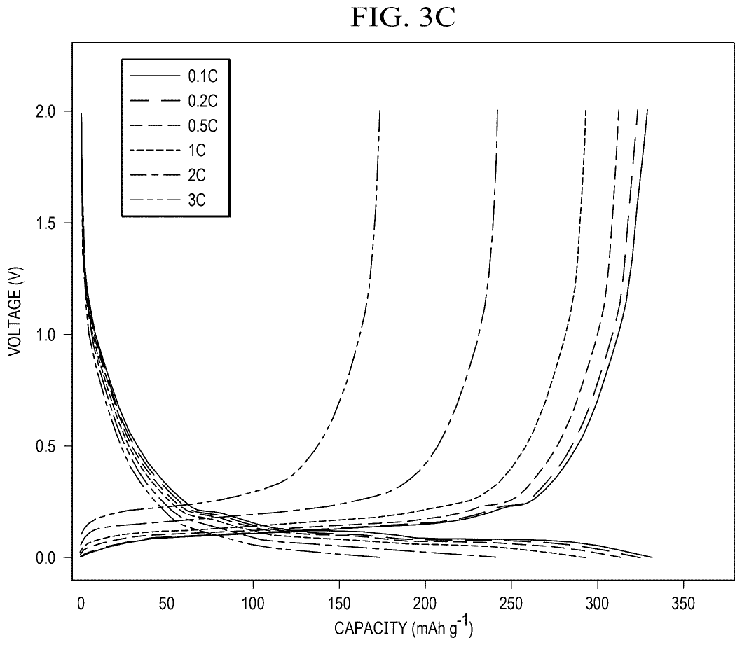

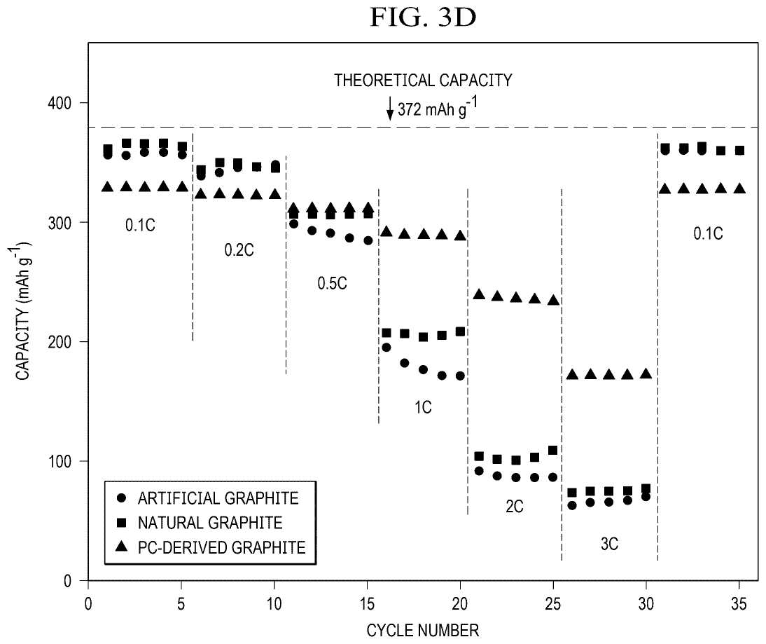

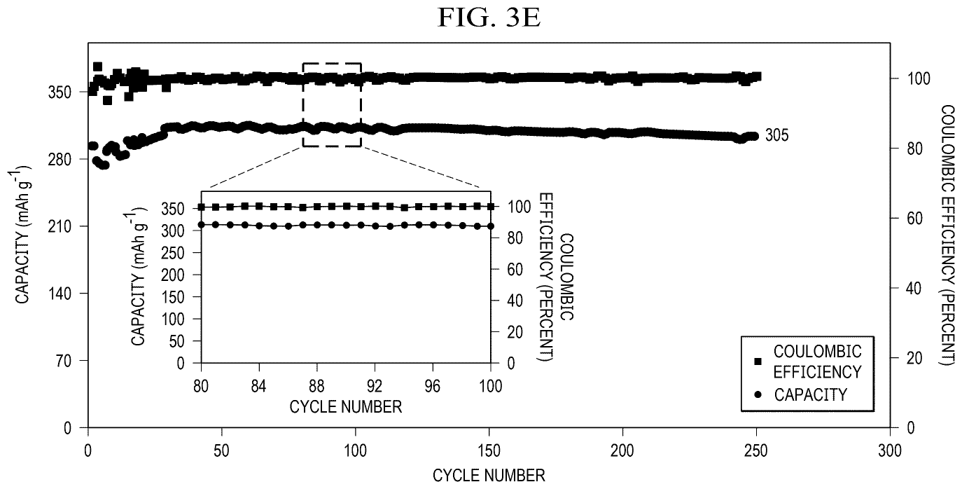

Coin-type half-cells were assembled using a LiPF-based electrolyte and a mass loading of approximately 1 mg/cm² with PC-derived graphite, synthetic graphite, and natural graphite. FIG. 3 presents a comprehensive electrochemical evaluation of lithium-ion battery (LIB) half-cells assembled with graphite derived from petroleum coke (PC), and compared against commercial natural graphite and artificial graphite. The data includes cyclic voltammetry (CV), galvanostatic charge-discharge (GCD), rate performance, and long-term cycling stability.

FIG. 3A shows the cyclic voltammetry (CV) curves of a LIB half-cell using PC-derived graphite recorded at a scan rate of 0.1 mV s⁻¹ in the potential range of 0.01-2.0 V (vs. Li/Li⁺). The CV profiles exhibit characteristic lithiation and delithiation peaks near 0.1 V and 0.25 V, respectively, which are typical of graphite-based anodes undergoing reversible intercalation of lithium ions. The first cycle displays a distinct irreversible peak around 0.7 V, corresponding to the formation of the solid electrolyte interphase (SEI) layer. Subsequent cycles show excellent overlap, indicating good electrochemical reversibility and stability of the PC-derived graphite. FIG. 3B compares the CV curves of PC-derived graphite with those of natural graphite and artificial graphite. All three exhibit similar redox features, indicating all three materials have similar lithiation properties.

FIG. 3C presents the galvanostatic charge-discharge (GCD) profiles of the LIB with PC-derived graphite at different C rates. The charge/discharge curves exhibit flat voltage plateaus typical of graphite, confirming a two-phase lithiation mechanism. In FIG. 3D, the rate capability of LIBs made with PC-derived graphite is compared with those using natural and artificial graphite across various current densities. The PC-derived graphite anode retains a higher capacity at increasing charging rates, outperforming both commercial graphites at C-rates greater than 0.5C. This superior rate performance can be attributed to the microstructure and morphology of the PC-derived graphite, which facilitates faster lithium-ion transport.

FIG. 3E displays the cycling performance of the PC-derived graphite-based LIB over 250 cycles at 0.5C charging rate. The battery retains over 90% of its initial capacity with nearly 100% Coulombic efficiency, confirming the excellent structural integrity and electrochemical stability of the PC-derived graphite. This stable cycling further validates the feasibility of using PC-derived graphite as a high-performance, low-cost alternative to conventional graphite sources in LIBs.

### Working Examples

### Experimental Methods and Materials:

### Materials:

Fuel-grade petroleum coke (supplied by Chevron), Dichloromethane (DCM), Iron powder, Nickel powder, Cobalt powder, Hydrochloric acid (37%), Sodium hydroxide (NaOH), polyvinylidene difluoride (PVDF, Mw˜600000 g/mol), N-Methyl-2-pyrrolidone (NMP), Cu foil, and Lithium hexafluorophosphate solution (in ethylene carbonate and dimethyl carbonate, 1.0 M LiPF6 in EC/DMC=50/50 (v/v)) were all purchased from Sigma Aldrich. Natural graphite (44 μm) was purchased from Thermo Fisher Scientific. Battery-grade synthetic graphite (20 μm), coin cell case (2032), Whatman Glass Fiber, and Lithium foil were purchased from MTI Corporation.

### Catalytic Graphitization of PC:

Fuel-grade PC is initially washed with DCM solvent and dried at 60° C. for 24 hours. The dried PC is ball-milled for 1 hour to produce a fine powder with a particle size of less than 200 microns. This PC powder is mixed with fine Fe powder in a 1:1 ratio and ball-milled for 20 minutes to achieve uniform mixing. The PC and Fe mixture is then formed into small pellets (D=10 mm, H=12 mm) using a hydraulic press under a 6-ton load.

The pellets are pyrolyzed in an argon atmosphere at different temperatures (1300, 1400, 1500, and 1600° C.) for various durations (3, 6, 12, and 24 hours). After pyrolysis, the pellets are crushed into powder and treated with 2M HCl at 80° C. for 3 hours to dissolve the Fe. This washing step is repeated twice. The treated PC powder is dried in a vacuum oven at 60° C. for 12 hours and then used for various characterizations and in Li-ion battery applications. The same procedure is followed for other catalysts, such as Ni and Co.

### Recovery and Reuse of Fe:

For the recovery and reuse of the catalyst (Fe), we used the iron hydroxide (Fe(OH)₂) precipitation process. A 4M NaOH solution was slowly added to the Fe-dissolved HCl solution while stirring continuously at 500 rpm. The pH of the solution was monitored, and NaOH addition was stopped once the pH reached 5, causing the Fe ions to precipitate as Fe(OH)₂. The precipitate was centrifuged, washed several times with deionized water, and annealed at 250° C. for 2 hours in air to convert it into iron oxide (Fe₂O₃). The resulting Fe₂O₃ was reused as a catalyst for the graphitization of fuel-grade PC using the same procedure. The neutralized HCl solution was then discarded.

### Material Characterization:

Scanning electron microscopy (SEM): High-resolution field emission scanning electron microscopes (JEOL JSM-7500F and FEI QUANTA 600) were used to examine PC derived graphite morphologies. Samples were sputter-coated with a 5 nm Pt/Pd layer using a Cressington 208HR sputter coater prior to imaging.

X-ray powder diffraction (XRD): XRD was performed by a Bruker D2 Phaser X-ray diffractometer with Cu radiation (kα=1.5407 Å) operated at 45 kV and 40 kA within a scanning range of 10° to 50°, with a step size 0.02° and rate of 1.2°/min. The obtained XRD profile of (002) peak was fitted using the Lorentzian profile on OriginPro 2015.

d spacing was calculated using Braggs' law by following the equation below.

$$n λ = 2 d ( sin θ ) \qquad ( 1 )$$

where λ is the wavelength of X-ray, d is the interlayer spacing of graphite, and θ is the position of (002) XRD peak.

The degree of graphitization (DG %) of graphite was calculated by the Maire-Mering equation 2.

$$DG \% = ( 0.344 - d ) / ( 0.344 - 0.3354 ) \qquad ( 2 )$$

where 0.3440 and 0.3354 are the d-spacings of non-graphitized carbon and the ideal graphite crystal, respectively.

### Raman Spectroscopy:

Raman spectroscopy measurements were performed with a confocal Raman microscope (Horiba Jobin-Yvon LabRam HR with Olympus BX 41 microscope) using a 633 nm 0.25 mW laser.

### Electrical Conductivity:

The electrical conductivity of PC derived graphite was measured using the four-point probe method with a Signatone S-302 Resistivity Stand and a Keithley 2000 multimeter.

### Electrochemical Performance of PC-Derived Graphite for Li-Ion Battery (LIB) Fabrication:

The electrochemical performance of PC-derived graphite was evaluated as negative electrodes for Li-ion batteries using CR2032 coin cells. The PC-derived graphite was mixed with polyvinylidene fluoride (PVDF) and conductive additive (Super P) in a mass ratio of 8:1:1 and dispersed in N-methyl-2-pyrrolidone (NMP) solvent. The resulting slurry was coated onto Cu foil, dried at 150° C. for 12 hours in a vacuum oven, and then cut into electrodes with a diameter of 12 mm. The mass loading of the electrolytic products in the electrodes was approximately 1 mg. The PC-derived graphite electrodes were assembled with Li metal into a half-cell for testing. Cyclic voltammetry (CV) was performed using a GAMRY electrochemical workstation, while the galvanostatic charge/discharge tests were conducted using a LAND battery testing system. All the batteries were assembled in an argon-filled glove box, maintaining oxygen and moisture levels below 0.1 ppm.

Beyond demonstrating competitive electrochemical performance, the catalytic graphitization process described herein also offers substantial energy savings compared with conventional Acheson-type methods. Industrial graphitization consumes about 7.7×103 kWh per ton of graphite, owing to extreme temperatures (>3000° C.) and long durations. In contrast, our Fe-catalyzed process achieves>97% graphitization at 1600° C. within 24 h, requiring only ˜825 kWh per ton (calculated based on heat losses from thermal radiation). This corresponds to an energy demand nearly one-ninth that of the conventional route, significantly lowering both production costs and associated CO₂ emissions. These benefits are amplified when renewable power is used, further reducing the carbon footprint of synthetic graphite production. Combined with catalyst recovery and reuse, the energy efficiency of this approach strengthens its industrial scalability and highlights catalytic graphitization as a practical pathway for low-carbon valorization of petroleum coke into sustainable energy storage materials.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A method of synthesizing graphite from petroleum coke, the method comprising:
forming particles of petroleum coke;
adding catalyst to the petroleum coke particles;
mixing the catalyst and the petroleum coke particles to achieve a homogeneous mixture;
forming the mixture into pellets by applying a compressive load; and
pyrolyzing the pellets in a furnace in the presence of argon to form graphite.

2. The method of claim 1, wherein the particles of petroleum coke are less than 200 μm in size.

3. The method of claim 1, wherein the particles of petroleum coke range in size from 10-200 μm.

4. The method of claim 1, wherein the ratio of petroleum coke to catalyst is about 1:1.

5. The method of claim 1, wherein the catalyst is selected from the group consisting of iron (Fe), cobalt (Co) and nickel (Ni).

6. The method of claim 1, wherein the mixing is performed via ball-milling.

7. The method of claim 1, wherein the pyrolysis is performed at less than 1600° C.

8. The method of claim 1, wherein the pyrolysis is carried out for a period of 12-24 hours.

9. A method of recovering catalyst used in the synthesis of graphite from petroleum coke according to claim 1, the method comprising:
grinding pyrolyzed pellets of graphite into a powder;
washing the pellet powder in an acid solution; and
separating the washed pellet powder comprising graphitized petroleum coke from the acid solution.

10. The method of claim 9, wherein the washing of the ground pellets is carried out in hydrochloric acid.

11. The method of claim 10, wherein the hydrochloric acid is at a concentration of 2M.

12. The method of claim 9, further comprising adding a base solution to the separated acid solution and precipitating a hydroxide salt of the catalyst.

13. The method of claim 12, wherein the base solution comprises sodium hydroxide.

14. The method of claim 13, wherein the concentration of sodium hydroxide is 4M.

15. The method of claim 12, wherein the hydroxide salt precipitate is converted to an oxide salt.

16. The method of claim 13, wherein the oxide salt is used as a catalyst for the graphitization of petroleum coke.

17. A lithium ion battery, wherein the battery comprises an anode prepared from graphite synthesized by the method of claim 1.
